(19) United States
(12) Patent Application Publication
(10) Pub. No.: US 2026/0110838 A1
(43) Pub. Date: Apr. 23, 2026

(54) OPTICAL INTERCONNECTIONS FOR SEMICONDUCTOR DEVICES

(71) Applicant: ADEIA SEMICONDUCTOR BONDING TECHNOLOGIES INC., San Jose, CA (US)

(72) Inventors: Belgacem HABA, Saratoga, CA (US); Rajesh KATKAR, Milpitas, CA (US); Cyprian Emeka UZOH, San Jose, CA (US)

(21) Appl. No.: 18/924,457

(22) Filed: Oct. 23, 2024

(51) Int. Cl. G02B 6/12

(52) U.S. Cl. CPC G02B 6/12004

(57) ABSTRACT

A structure is disclosed. The structure can include a first plurality of integrated device dies, an interconnect device, and an optical unit. The interconnect device can be electrically connected to the first plurality of integrated device dies. The optical unit can be disposed vertically above the interconnect device. The optical unit can be optically connected to an optical interconnect. The first plurality of integrated device dies can communicate with a second plurality of integrated device dies at least through the interconnect device, the optical unit, and the optical interconnect.

### BACKGROUND

### Field

This disclosure relates to semiconductor device structures and methods. In particular, some embodiments are directed to optical devices for connecting semiconductor dies.

### Description of Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

As demand for communication bandwidth continues to increase, existing methods such as using copper wires to connect multiple semiconductor dies or integrated device dies may face limitations at least in terms of energy consumption and scalability. It may be desirable to find a new interconnect scheme for facilitating communications between semiconductor devices.

### BRIEF DESCRIPTION OF THE DRAWINGS

These and other features, aspects, and advantages of the disclosure are described with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 illustrates top schematic views of semiconductor devices using metal wires connecting high bandwidth memories and processor dies.

FIG. 2 illustrates a top schematic view of a bonded structure with memory units and processor dies interconnected via optical interconnects and interconnect devices according to some embodiments.

FIG. 3 illustrates a top schematic view of a bonded structure with a cluster of processor dies and a cluster of memory units interconnected via optical interconnects and interconnect devices according to some embodiments.

FIG. 4 illustrates a top schematic view of a bonded structure with a cluster of processor dies and a cluster of memory units interconnected at least via an optical multiplexer according to some embodiments.

FIG. 5 illustrates a top schematic view of another example implementation of a bonded structure with a cluster of processor dies and a cluster of memory units interconnected at least via an optical multiplexer according to some embodiments.

FIG. 6 illustrates a top schematic view of another example implementation of a bonded structure with a first cluster of processor dies and a second cluster of processor dies interconnected via optical interconnects and interconnect devices according to some embodiments.

FIG. 7 illustrates a top schematic view and a side schematic sectional view of a bonded structure with a first plurality of processor dies and a second plurality of processor dies interconnected via an optical interconnect and interconnect devices according to some embodiments.

FIG. 8 illustrates a top schematic view and a side schematic sectional view of a bonded structure with a plurality of processor dies and a plurality of memory dies interconnected via an optical interconnect and interconnect devices according to some embodiments.

FIG. 9 illustrates a top schematic view and a side schematic sectional view of a bonded structure with a plurality of processor dies connected to an optical multiplexer through an optical interconnect according to some embodiments.

FIG. 10 illustrates a top schematic view and a side schematic sectional view of a bonded structure with a plurality of memory dies connected to an optical multiplexer through an optical interconnect according to some embodiments.

FIG. 11 illustrates a side schematic sectional view of a bonded structure with a plurality of processor dies, an interconnect device, an optical unit, and an optical interconnect according to some embodiments.

FIGS. 12A and 12B schematically illustrate cross-sectional side views of two elements prior to and after, respectively, a process for forming a directly bonded structure, and more particularly a hybrid bonded structure, according to some embodiments.

### SUMMARY

The systems, methods, and devices described herein each have several aspects, no single one of which is solely responsible for its desirable attributes. Without limiting the scope of this disclosure, several non-limiting features will now be described briefly.

In some aspects, the techniques described herein relate to a structure including: a first plurality of integrated device dies; an interconnect device electrically connected to the first plurality of integrated device dies; and an optical unit disposed vertically above the interconnect device, the optical unit optically connecting to an optical interconnect, wherein the first plurality of integrated device dies communicate with a second plurality of integrated device dies at least through the interconnect device, the optical unit, and the optical interconnect.

In some aspects, the techniques described herein relate to a structure, wherein the interconnect device electrically connects the first plurality of integrated device dies with each other.

In some aspects, the techniques described herein relate to a structure, wherein the interconnect device converts an electrical signal received from the first plurality of integrated device dies to an optical signal.

In some aspects, the techniques described herein relate to a structure, wherein the optical unit transmits the optical signal through the optical interconnect.

In some aspects, the techniques described herein relate to a structure, wherein the interconnect device converts an optical signal received from the optical unit to an electrical signal.

In some aspects, the techniques described herein relate to a structure, wherein the interconnect device transmits the electrical signal to the first plurality of integrated device dies.

In some aspects, the techniques described herein relate to a structure, wherein the interconnect device includes an optical driver die or an optical modulator die.

In some aspects, the techniques described herein relate to a structure, wherein the interconnect device includes a bridge die.

In some aspects, the techniques described herein relate to a structure, wherein the interconnect device includes a single die that includes an optical driver and a bridge.

In some aspects, the techniques described herein relate to a structure, wherein each of the first plurality of integrated device dies includes a graphics processing unit (GPU), a central processing unit (CPU), a neural networking processing unit (NPU), a tensor processing unit (TPU), a network switch integrated circuit, or a system on a chip (SOC).

In some aspects, the techniques described herein relate to a structure, wherein each of the second plurality of integrated device dies includes a memory die.

In some aspects, the techniques described herein relate to a structure, wherein each of the second plurality of integrated device dies includes a graphics processing unit (GPU), a central processing unit (CPU), or a system on a chip (SOC).

In some aspects, the techniques described herein relate to a structure, wherein the interconnect device is disposed vertically above the first plurality of integrated device dies.

In some aspects, the techniques described herein relate to a structure, wherein the first plurality of integrated device dies are disposed in a first cluster region, and the second plurality of integrated device dies are disposed in a second cluster region.

In some aspects, the techniques described herein relate to a structure, wherein the first cluster region is away from the second cluster region above a distance to prevent thermal coupling between the first cluster region and the second cluster region.

In some aspects, the techniques described herein relate to a structure, wherein the optical unit transmits or receives an optical signal through the optical interconnect.

In some aspects, the techniques described herein relate to a structure, wherein the optical unit includes a diode.

In some aspects, the techniques described herein relate to a structure, wherein the optical interconnect includes an optical fiber.

In some aspects, the techniques described herein relate to a structure, wherein the interconnect device is hybrid bonded to the first plurality of integrated device dies.

In some aspects, the techniques described herein relate to a structure, wherein the optical unit is hybrid bonded to the interconnect device.

In some aspects, the techniques described herein relate to a structure including: a first plurality of integrated device dies; a first interconnect device electrically connected to the first plurality of integrated device dies; a first optical unit disposed vertically above the first interconnect device; and an optical interconnect including a first end and a second end, the first end of the optical interconnect optically connecting to the first optical unit, wherein the first plurality of integrated device dies communicate with a second plurality of integrated device dies at least through the first interconnect device, the first optical unit, and the optical interconnect.

In some aspects, the techniques described herein relate to a structure, further including: the second plurality of integrated device dies; a second interconnect device electrically connected to the second plurality of integrated device dies; and a second optical unit disposed vertically above the second interconnect device, the second end of the optical interconnect optically connecting to the second optical unit.

In some aspects, the techniques described herein relate to a structure, wherein the first interconnect device electrically connects the first plurality of integrated device dies with each other.

In some aspects, the techniques described herein relate to a structure, wherein the first interconnect device is disposed vertically above the first plurality of integrated device dies.

In some aspects, the techniques described herein relate to a structure including: a first plurality of integrated device dies; a first interconnect device electrically connected to the first plurality of integrated device dies; and a first optical unit disposed vertically above the first interconnect device, wherein the first interconnect device and the first optical unit enable the first plurality of integrated device dies to communicate with a second plurality of integrated device dies.

In some aspects, the techniques described herein relate to a structure, further including: an optical multiplexer device; a second optical unit disposed vertically above the optical multiplexer device; and a first optical interconnect optically connecting the first optical unit and the second optical unit.

In some aspects, the techniques described herein relate to a structure, further including: the second plurality of integrated device dies; a second interconnect device electrically connected to the second plurality of integrated device dies; a third optical unit disposed vertically above the second interconnect device; and a second optical interconnect optically connecting the second optical unit and the third optical unit, wherein the first plurality of integrated device dies communicate with the second plurality of integrated device dies at least through the first interconnect device, the first optical unit, the first optical interconnect, the second optical unit, the optical multiplexer device, the second optical interconnect, the third optical unit, and the second interconnect device.

In some aspects, the techniques described herein relate to a structure, wherein the first interconnect device electrically connects the first plurality of integrated device dies with each other.

In some aspects, the techniques described herein relate to a structure, wherein the first plurality of integrated device dies include two, three, or four integrated device dies.

In some aspects, the techniques described herein relate to a structure, wherein the first interconnect device is disposed vertically above the first plurality of integrated device dies.

In some aspects, the techniques described herein relate to a structure including: a first plurality of integrated device dies; a first interconnect device electrically connected to the first plurality of integrated device dies; a first optical unit disposed vertically above the first interconnect device; a first optical interconnect optically connecting the first optical unit and a second optical unit; an optical multiplexer device; and the second optical unit disposed vertically above the optical multiplexer device, wherein the second optical unit is optically connected to a third optical unit through a second optical interconnect.

In some aspects, the techniques described herein relate to a structure, wherein the first interconnect device is disposed vertically above the first plurality of integrated device dies.

In some aspects, the techniques described herein relate to a structure, further including: a second plurality of integrated device dies; a second interconnect device electrically connected to the second plurality of integrated device dies; the third optical unit disposed vertically above the second interconnect device; and the second optical interconnect, wherein the first plurality of integrated device dies communicate with the second plurality of integrated device dies at least through the first interconnect device, the first optical unit, the first optical interconnect, the second optical unit, the optical multiplexer device, the second optical interconnect, the third optical unit, and the second interconnect device.

In some aspects, the techniques described herein relate to a structure, wherein the second optical unit is optically connected to a fourth optical unit through a third optical interconnect.

In some aspects, the techniques described herein relate to a structure including: a first plurality of integrated device dies; an interconnect device electrically connected to the first plurality of integrated device dies; a first optical unit disposed vertically above the interconnect device; an optical interconnect optically connecting the first optical unit and a second optical unit; an optical multiplexer device; and the second optical unit disposed vertically above the optical multiplexer device.

In some aspects, the techniques described herein relate to a structure, wherein the interconnect device, the first optical unit, the optical interconnect, the second optical unit, and the optical multiplexer device enable the first plurality of integrated device dies to communicate with a second plurality of integrated device dies.

In some aspects, the techniques described herein relate to a structure including: a first plurality of integrated device dies; a first interconnect device electrically connected to the first plurality of integrated device dies; and a first optical unit disposed vertically above the first interconnect device, wherein the first interconnect device is directly bond to the first optical unit without in intervening organic adhesive layer. 38.

Various combinations of the above and below recited features, embodiments, and aspects are also disclosed and contemplated by the present disclosure.

Additional embodiments of the disclosure are described below in reference to the appended claims, which may serve as an additional summary of the disclosure.

### DETAILED DESCRIPTION

Although several embodiments, examples, and illustrations are disclosed below, it will be understood by those of ordinary skill in the art that the disclosure described herein extends beyond the specifically disclosed embodiments, examples, and illustrations and includes other uses of the disclosure and obvious modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of some specific embodiments of the disclosure. In addition, embodiments can comprise several novel features. No single feature is solely responsible for its desirable attributes or is essential to practicing the disclosure herein described.

In the era of artificial intelligence or high-performance computing, existing methods for connecting multiple semiconductor dies or integrated device dies may face limitations in terms of energy consumption and scalability. Some embodiments disclosed herein nevertheless accomplish efficient, scalable, and/or low latency interconnections or communications between semiconductor devices using optical interconnects and/or optical multiplexing devices.

There is increasing demand for higher bandwidth communications between semiconductor devices. Providing high speed, high bandwidth connections between large number of semiconductor devices such as processors and memory can be important for some applications. For example, when training an artificial intelligence or machine learning model, performing complex graphical operations, or carrying out other data-intensive tasks, processors such as central processing units (CPUs), graphical processing units (GPUs), field programmable gate arrays (FPGAs), Neural Processing Units (NPUs), Tensor Processing Units (TPUs), application specific integrated circuits (ASICs), and so forth can spend a significant amount of time idle while waiting for data from other processors and memory devices like high bandwidth memory (HBM), storage class memory (e.g. NAND), etc., which can negatively impact performance and increase the time it takes to complete a given or multiple computing tasks.

As the number of semiconductor dies (e.g., multiple processor chiplet cores, memory units, or the like) integrated into a system and the need for high-speed data transfer grow, existing methods of connecting semiconductor dies may face limitations in terms of energy consumption and scalability. More specifically, current solutions for interconnecting semiconductor devices often involve complex wiring schemes and/or multiple layers of interposers or stacked metal interconnects structures. These solutions can lead to increased communication latency, higher power consumption, and thermal management challenges. For example, to communicate with a high bandwidth memory, a processor die may need to rely on another processor die to relay signal to the high bandwidth memory. This may increase communication latency and/or jam communications among processor dies and high bandwidth memories.

Additionally, copper wire communication has historically been a preferred method for data transfer (e.g., short-distance data transfer) due to the reliability and established infrastructure. However, copper wires may exhibit high energy consumption, heating issues and limited scalability, which can restrict their effectiveness in modern high-bandwidth applications. The physical constraints of copper wires, such as signal attenuation and electromagnetic interference, limited signal speed in copper wires, etc. may further hinder their performance in densely packed semiconductor environments where, for example, a large number of input/output (I/O) communication interfaces are present. The reliance on copper wires for interconnects may also limit the potential for miniaturization and integration of semiconductor devices, as the physical space required for wiring becomes a bottleneck. Also, in densely packed submicron scale copper wires, resistance heating from the fine wire may pose a serious device reliability and electromigration concern. For example, for a given voltage, more heat is generated within wiring elements with a pitch of 50 nanometer (nm) as compared to wiring elements with a pitch of 100 nm.

However, the advent of optical communication characterized by lower optical energy consumption (e.g., less than one picojoule per bit or 1 pJ/bit), significantly lower latency (optical signal travels in a fiber than electrical signal in a copper wire) and/or hybrid bonding technologies capable of handling a large number of I/O (e.g., over hundreds of thousands of I/O interfaces within millimeter squares of area) communication have introduced a competitive alternative for chip-to-chip communication, board-to-board communication, server-to-server communication, or rack-to-rack communication (e.g., communication over relatively short distances). As such, to address at least a portion of the aforementioned problems, some embodiments herein utilize optical components (e.g., optical interconnects, optical units, and/or optical multiplexers) for connecting semiconductor dies or integrated device dies in semiconductor packages. In some embodiments, a bonded structure in a semiconductor package may leverage optical interconnects and interconnect devices to facilitate high-speed data transfer between integrated device dies. For example, an interconnect device can be hybrid bonded to integrated device dies, and an optical unit can be hybrid bonded to the interconnect device. More specifically, the interconnect device may include a bridge die and an optical driver die, or may be a single die that includes an optical driver and a bridge. The optical unit can include an optical source (e.g., a light emitting diode (LED), a laser, a laser diode, etc. ). The integrated device dies can communicate with other integrated device dies through the interconnect device, the optical unit, and one or more optical interconnects or links (e.g., optical fibers).

By leveraging optical interconnects and interconnect devices, a bonded structure may enable multiple integrated device dies to directly communicate (e.g., through “many-to-many” communication) with each other. In some embodiments, a first plurality of integrated device dies (e.g., processor dies or memory dies) may communicate directly with a second plurality of integrated device dies (e.g., processor dies or memory dies) without the need for intermediary dies (e.g., a processor die that relays communication from a memory die to another processor die). Such direct and/or “many-to-many” communication may reduce latency and improve processing (e.g. computing) capacity and data transfer capability associated with the bonded structure.

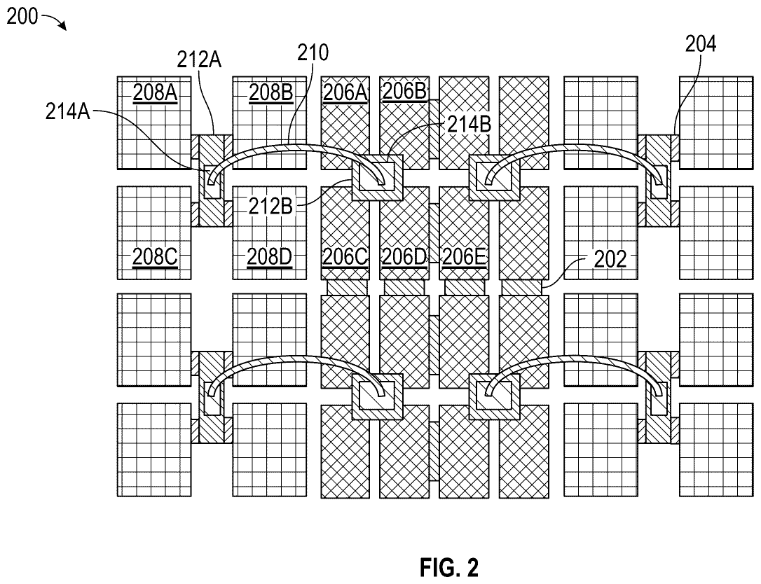

The bonded structure (e.g., bonded structures that will be discussed below with reference to FIGS. 2-6) that enables multiple integrated device dies to directly communicate with each other can be useful for intensive computing applications (e.g., artificial intelligence and machine learning), where demand for processing power and memory access is immense. For example, large language models and training algorithms may require extensive computational resources, which often necessitates communication between a large number of processors and memory units. However, architectural design, computing and memory resource management can be challenging. In some cases, a large number of processors and/or memory units may be utilized to train a large language model, and the large number of processors and/or memory units may not be accommodated on a single board, server blade, or rack due to physical and thermal constraints. Instead, the processors and/or memory units may be disaggregated or distributed into several smaller clusters of processors and/or clusters of memory units. By utilizing optical interconnects and interconnect devices (e.g., optical multiplexers, optical units, optical switches, or the like), a bonded structure disclosed herein can advantageously enable efficient communication and data transfer between clusters of processors and/or clusters of memory units. As such, the bonded structure can allow for the distribution of large computing workloads across multiple clusters, optimizing performance and efficiency. By accessing and processing data from several memory clusters, the bonded structure can handle complex tasks effectively and support high-performance computing applications.

Additionally and/or optionally, the bonded structure may further employ optical multiplexer(s) to facilitate efficient communication between integrated device dies. In some embodiments, an optical multiplexer may enable multiple optical signals to be combined and/or transmitted over one or more optical fibers, thereby significantly increasing data transfer capacity of the bonded structure. This multiplexing capability may allow for more efficient use of the available bandwidth, reduce the need for multiple physical connections, and/or simplify the interconnection architecture associated with the bonded structure. The optical multiplexer may also facilitate optical communication between multiple integrated device dies by enabling multiple data streams to be transmitted simultaneously through multiple optical interconnects, and may be capable of supporting a large number of I/O connections between integrated device dies. As such, the bonded structure may advantageously achieve improved scalability and flexible interconnections among integrated device dies.

By utilizing optical signals instead of solely relying on electrical signals for communication, the bonded structure may significantly reduce energy consumption and enhance scalability. The reduced energy consumption may result in less heat generated, which is beneficial for thermal management within semiconductor packages. Additionally, higher data transfer rates may be achieved through optical communication. In some embodiments, optical fibers utilized by a bonded structure may transmit data at speeds over terabits per second (Tbps), and may exceed data transfer capability of electrical interconnects. Utilizing optical components for communication may also mitigate issues related to signal attenuation and electromagnetic interference, providing a more reliable and efficient interconnect solution for modern semiconductor devices.

### Conventional Semiconductor Devices

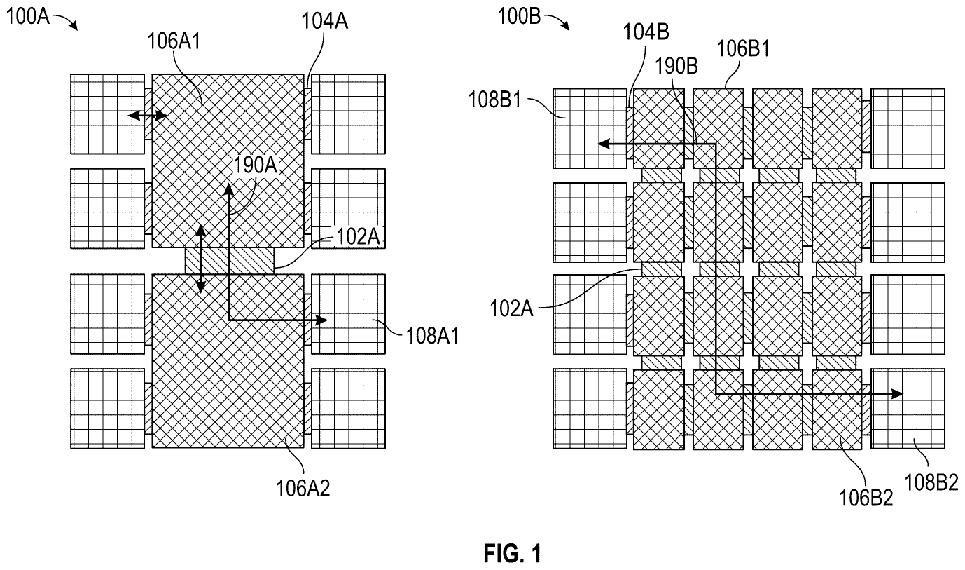

FIG. 1 illustrates top schematic views of a semiconductor device 100A and a semiconductor device 100B that use metal wires for connecting high bandwidth memories and processor dies. As shown in FIG. 1, the semiconductor device 100A includes at least a processor die 106A1, a processor die 106A2, a connecting element 102A, connecting elements 104A, and memory units 108A1. The connecting elements 104A connect the memory units 108A1 and the processor dies 106A1, 106A2. As such, the processor die 106A1 may access a memory unit 108A1 through a connecting element 104A. The connecting element 102A may connect the processor dies 106A1, 106A2. As such, the processor die 106A1 and the processor die 106A2 may communicate with each other through the connecting element 102A.

In some embodiments, the processor die 106A1 can be a GPU die, a CPU die, a NPU die, a TPU die, a network switch, an FPGA, an ASIC, or the like. The processor die 106A2 can be a GPU die, a CPU die, or the like.

In some embodiments, the connecting element 102A or the connecting elements 104A may be implemented as metal traces embedded in a substrate (not shown in FIG. 1). For example, the metal traces embedded in the substrate may be copper traces that form electrical pathways between components of the semiconductor device 100A. In other embodiments, connecting element 102A or the connecting elements 104A may be implemented as element(s) (e.g., a bridge, a silicon bridge chip, an organic bridge, redistribution layer (RDL), organic routing layer, etc.) separate from the substrate. In some embodiments, the connecting elements 102A and 104A can comprise of at least a multilayer interconnect structure.

In the semiconductor device 100A, the path 190A in the semiconductor device 100A indicates that the processor die 106A1 needs to communicate with the memory unit 108A1 through the processor die 106A2. This indirect communication may lead to increased communication latency and inefficiency, as data need to pass through an intermediary processor die (e.g., the processor die 106A2) before reaching the target memory unit 108A1.

The semiconductor device 100B includes at least a processor die 106B1, a processor die 106B2, a memory unit 108B1, a memory unit 108B2, connecting elements 104B, and connecting elements 102A. The connecting elements 104B connect the memory units 108B1 and 108B2 to processor dies (e.g., the processor dies 106B1, 106B2). As such, the processor die 106B1 may access the memory unit 108B1 through a connecting element 104B. The connecting elements 102A may connect processor dies. As such, the processor die 106B1 and the processor die 106B2 may communicate with each other through the connecting elements 102A.

In some embodiments, the processor die 106B1 can be a GPU die, a CPU die, or the like. The processor die 106B2 can be a GPU die, a CPU die, a NPU die, a TPU, die, an ASIC, a network switch, an FPGA, or the like.

In some embodiments, the connecting element 104B may be implemented as metal traces embedded in a substrate (not shown in FIG. 1). For example, the metal traces embedded in the substrate may be copper traces that form electrical pathways between components of the semiconductor device 100B. In other embodiments, connecting element 104B may be implemented as element(s) (e.g., a bridge) separate from the substrate. Also, the connecting element 104B can comprise of at least a multilayer interconnect structure.

In the semiconductor device 100B, the path 190B indicates that memory unit 108B1 needs to communicate with the memory unit 108B2 through several processor dies, including the processor die 106B1 and the processor die 106B2. This complex and indirect communication may lead to increased communication latency and inefficiency, as data need to pass through an intermediary processor die (e.g., the processor dies 106B1, 106B2) before reaching the target memory unit 108B2.

As noted above, some implementations disclosed herein can significantly improve latency and/or increase memory bandwidth by using optical components (e.g., optical interconnects, optical units, and/or optical multiplexers) for connecting semiconductor dies or integrated device dies in semiconductor packages. For example, an interconnect device can be hybrid bonded to integrated device dies, and an optical unit can be hybrid bonded to the interconnect device. The integrated device dies can communicate with other integrated device dies through the interconnect device, the optical unit, and one or more optical interconnects or links (e.g., optical fibers).

### Example Bonded Structures

FIG. 2 illustrates a top schematic view of a bonded structure 200 with memory units and processor dies interconnected via optical interconnects and interconnect devices according to some embodiments. The bonded structure 200 includes at least memory units 208A, 208B, 208C, 208D, processor dies 206A, 206B, 206C, 206D, 206E, connecting elements 204 (between memory units), connecting elements 202 (between processor dies), interconnect devices 212A, 212B, optical units 214A, 214B, and optical interconnects 210.

As shown in FIG. 2, connecting elements 202 can electrically connect processor dies. For example, a connecting element 202 electrically connects processor die 206D and processor die 206E. In some embodiments, a connecting element 202 can be bonded (e.g., directly bonded, bonded using micro bumps, solder attach, or deposited such as build up wiring layers) to processor dies. For example, connecting elements 202 can be bonded to processor dies 206B, 206C, 206D, 206E. Connecting elements 202 can provide at least electrical communication between processor dies (e.g., the processor die 206D and the processor die 206E). A connecting element 202 can comprise one or more layers and materials for facilitating electrical communication. A connecting element 202 can be a bridge and/or an interposer, and can include metal traces, through-substrate-vias (TSVs), optical waveguides (e.g. silicon, oxide or nitride layers or channels), redistribution layers (RDLs), and/or conductors that may each include one or more vias (e.g., vertical electrical connections) and/or one or more traces (e.g., lateral electrical connections). For example, the connecting element 202 may be patterned metal or metal traces in a substrate (not shown in FIG. 2) of the bonded structure 200. As another example, the connecting element 202 may be a structure (e.g., a bridge) separate from the substrate.

Connecting elements 204 can electrically connect memory units. For example, a connecting element 204 electrically connects memory unit 208A and memory unit 208B, and another connecting element 204 electrically connects memory unit 208C and memory unit 208D. In some embodiments, a connecting element 204 can be bonded (e.g., directly bonded or deposited such as build up wiring layers) to memory units. For example, a connecting element 204 can be bonded to memory units 208A, 208B. As another example, another connecting element can be bonded to memory units 208C, 208D. Connecting elements 204 can provide at least electrical communication between memory units (e.g., the memory unit 208C and the memory unit 208D). A connecting element 204 can be similar to a connecting element 202, and can comprise one or more layers and materials for facilitating electrical communication. A connecting element 204 can be a bridge and/or an interposer, and can include metal traces, through-substrate-vias (TSVs), optical waveguides (e.g. silicon, oxide or nitride layers or channels), redistribution layers (RDLs), and/or conductors that may each include one or more vias (e.g., vertical electrical connections) and/or one or more traces (e.g., lateral electrical connections). For example, the connecting element 204 may be patterned metal or metal traces in a substrate (not shown in FIG. 2) of the bonded structure 200. As another example, the connecting element 204 may be a structure (e.g., a bridge) separate from the substrate.

In some embodiments, a connecting element 202 and/or a connecting element 204 can include one or more dielectric layers (not shown) that surround one or more conductive layers to provide electrical insulation and structural support. In some embodiments, the one or more dielectric layers can include inorganic layers, such as silicon oxide, silicon nitride, silicon oxynitride, silicon carbonitride, or any other dielectric that can form a hybrid bondable surface. Additionally or alternatively, the one or more dielectric layers can include one or more organic layers with bondable dielectric(s), such as inorganic dielectric, disposed over or under the organic layers. As noted above, the connecting element 202 and/or the connecting element 204 can additionally and/or optionally include one or more redistribution layers (RDL). The one or more RDL may be deployed on one or both sides of the connecting element 202 and/or the connecting element 204. In some embodiments, the connecting element 202 and/or the connecting element 204 may comprise passive elements such as resistors, capacitors, inductors, micro-electrical mechanical system (MEMS), modulators, couplers, optical elements, and/or the like. In some embodiments, the connecting element 202 and/or the connecting element 204 may comprise an active (or functional) semiconductor materials (e.g. active bridge or active interposer fabricated using silicon or heterogenous materials).

Interconnect devices 212A, 212B electrically connect some memory units and some processor dies. For example, an interconnect device 212A or 212B and connecting elements 204 can electrically connect memory units 208A, 208B, 208C, 208D. As another example, an interconnect device 212B electrically connects processor dies 206A, 206B, 206C, 206D. In some embodiments, interconnect devices 212A can be disposed (e.g., bonded, such as directly bonded using ZIBOND® or DBI® hybrid bonding technique without adhesive or an intervening layer or flip chipped or micro-bumped) above the connecting elements 204. For example, an interconnect device 212A can be hybrid bonded to two connecting elements 204 such that the memory units 208A, 208B, 208C, 208D may communicate with each other through the interconnect device 212A and the two connecting elements 204. The interconnect device 212A can comprise one or more layers and materials for facilitating electrical communication. For example, the interconnect device 212A can include one or more conductive layers that accommodate conductors, where each of the conductors may include one or more vias (e.g., vertical electrical connections) and/or one or more traces (e.g., lateral electrical connections).

In some embodiments, an interconnect device 212A may include a bridge die and an optical driver die. In other embodiments, an interconnect device 212A may comprise a single die that includes an optical driver and a bridge. The interconnect device 212A (e.g., a bridge die or a bridge chip of the interconnect device 212A) may route electrical signals between memory units 208A, 208B, 208C, 208D, perform signal conversion (e.g., converting parallel signals to serial signals, or vice versa), and/or provide electrical isolation between memory units 208A, 208B, 208C, 208D to reduce interference or crosstalk. The interconnect device 212A (e.g., an optical driver/modulator die or chip of the interconnect device 212A) may also convert electrical signals into optical signals, and vice versa, so as to enable optical communication within the bonded structure 200. For example, an optical driver/modulator die of the interconnect device 212A may convert electrical signals received from the memory units 208A, 208B, 208C, 208D into optical signals. The optical driver/modulator die may perform the conversion using components such as laser diodes, lasers, light-emitting diodes (LEDs), or other devices that generate optical signals based on electrical signals. As another example, the optical driver/modulator die of the interconnect device 212A may convert (e.g., using photodetectors) incoming optical signals (e.g., received from an optical unit 214A) into electrical signals that will be transmitted to the memory units 208A, 208B, 208C, 208D. As yet another example, the optical driver/modulator die of the interconnect device 212A may modulate (e.g., using techniques such as amplitude modulation, phase modulation, and/or frequency modulation) optical signals to encode data for optical transmission.

In some embodiments, interconnect devices 212B can be disposed (e.g., bonded, such as directly bonded using ZIBOND® or DBI® hybrid bonding technique without adhesive or an intervening layer or flip chipped or micro-bumped) above processor dies. For example, an interconnect device 212B can be hybrid bonded to the processor dies 206A, 206B, 206C, 206D. As such, the interconnect devices 212B may allow the processor dies 206A, 206B, 206C, 206D to electrically communicate with each other through the interconnect device 212B. The interconnect device 212B can comprise one or more layers and materials for facilitating electrical communication. For example, the interconnect device 212B can include one or more conductive layers that accommodate conductors, where each of the conductors may include one or more vias (e.g., vertical electrical connections) and/or one or more traces (e.g., lateral electrical connections).

An interconnect device 212B may be structurally and/or functionally similar to an interconnect device 212A. In some embodiments, an interconnect device 212B may include a bridge die and an optical driver die. In other embodiments, an interconnect device 212B may comprise a single die that includes an optical driver and a bridge. The interconnect device 212B (e.g., a bridge die or a bridge chip of the interconnect device 212B) may route electrical signals between processor dies 206A, 206B, 206C, 206D. The interconnect device 212B (e.g., an optical driver/modulator die or chip of the interconnect device 212A) may also convert electrical signals into optical signals, and vice versa, so as to enable optical communication within the bonded structure 200. For example, an optical driver/modulator die of the interconnect device 212B may convert and process electrical signals received from the processor dies 206A, 206B, 206C, 206D into optical signals. The optical driver/modulator die may perform the conversion using components such as laser diodes, light-emitting diodes (LEDs), or other devices that generate optical signals based on electrical signals. As another example, the optical driver/modulator die of the interconnect device 212B may convert (e.g., using photodetectors) incoming optical signals (e.g., received from an optical unit 214B) into electrical signals using operational amplifiers (e.g. trans-impedance amplifiers) that will be transmitted to the processor dies 206A, 206B, 206C, 206D. As yet another example, the optical driver/modulator die of the interconnect device 212B may modulate (e.g., using techniques such as amplitude modulation, phase modulation, and/or frequency modulation) optical signals to encode data for optical transmission.

The processor dies 206A, 206B, 206C, 206D can be GPU dies, CPU dies, TPU dies, NPU dies, network switch integrated circuits, and/or any combination thereof. In some embodiments, each of the processor dies 206A, 206B, 206C, 206D can be a GPU chiplet. Each of the processor dies 206A, 206B, 206C, 206D can be soldered to a substrate (not shown) of the bonded structure 200 or hybrid bonded to the substrate if the substrate has a bondable surface. In some embodiments, the processor dies 206A, 206B, 206C, 206D may be laterally spaced from each other. In some embodiments, the processor dies 206A, 206B, 206C, 206D may comprise of dies with different sizes. For example, the width of a first processor die may be at least 10% larger than the width of a second processor die.

The memory units 208A, 208B, 208C, 208D can each comprise a single memory die or a plurality of (e.g., two, three, four, five, twelve, sixteen, or the like) memory dies or memory die stack (e.g., DRAM dies) hybrid bonded to and stacked on one another. Each of the processor dies 208A, 208B, 208C, 208D can be soldered to a substrate (not shown) of the bonded structure 200 or hybrid bonded to the substrate if the substrate has a bondable surface. In some embodiments, the memory units 208A, 208B, 208C, 208D may be laterally spaced from each other.

An optical unit 214A can be disposed (e.g., bonded, such as directly bonded using ZIBOND® or DBI® hybrid bonding technique without adhesive or an intervening layer) on an interconnect device 212A to be vertically above the interconnect device 212A. In some embodiments, an optical unit 214A can transmit optical signals generated by an optical driver/modulator chip within the interconnect device 212A. The optical unit 214A may utilize component(s) such as laser diodes or light-emitting diodes (LEDs) to transmit optical signals through an optical interconnect 210 to achieve high-speed data transfer. The optical unit 214A can also receive optical signals from the optical interconnect 210 and transmit the received optical signals to the optical driver/modulator chip within the interconnect device 212A. The optical unit 214A can optionally include optical waveguides to guide optical signals to and from various components (e.g., laser diodes, LEDs, photodetectors, or the like). The optical unit 214A may be optically aligned with the interconnect device 212A to reduce signal loss and preserve signal integrity.

Optical unit 214B can be disposed (e.g., bonded, such as directly bonded using ZIBOND® or DBI® hybrid bonding technique without adhesive or an intervening layer) on interconnect devices 212B to be vertically above the interconnect device 212B. In some embodiments, an optical unit 214B can transmit optical signals generated by an optical driver/modulator chip within the interconnect device 212B. The optical unit 214B may utilize component(s) such as laser diodes or light-emitting diodes (LEDs) to transmit optical signals through an optical interconnect 210 to achieve high-speed data transfer. The optical unit 214B can also receive optical signals from the optical interconnect 210 and transmit the received optical signals to the optical driver/modulator chip within the interconnect device 212B. The optical unit 214B can optionally include optical waveguides to guide optical signals to and from various components (e.g., laser diodes, LEDs, photodetectors, or the like). The optical unit 214B may be optically aligned with the interconnect device 212B to reduce signal loss and preserve signal integrity.

In some embodiments, the optical unit 214A and/or the optical unit 214B can include a photonic integrated circuit (PIC), an electronic integrated circuit (EIC), or any combination thereof. The PIC can integrate multiple photonic functions on a single chip, enabling the manipulation of light for various applications such as data transmission, signal processing, and sensing. Typical building blocks of the PIC can include waveguides, modulators, detectors, and lasers, which collectively facilitate the conversion and routing of optical signals. These components can coordinate with each other to achieve high-speed data transfer with reduced latency and energy consumption. The EIC can perform electronic signal processing and control functions. EICs typically include transistors, resistors, capacitors, and other electronic components that manage electrical signals. In the context of packaged optics, EICs can interface with PICs to convert electrical signals into optical signals and vice versa. This conversion enables effective communication between electronic and photonic domains, thereby enhancing the overall performance and efficiency of the bonded structure 200. As noted above, the optical unit 214A and/or the optical unit 214B can integrate a PIC, an EIC, or any combination of PICs and EICs. This integration can advantageously allow for the co-packaging of optical and electronic components, facilitating direct communication between processors and memory units through optical interconnects. By leveraging PIC(s) and/or EIC(s), the optical unit 214A and/or the optical unit 214B can support high-bandwidth, low-latency data transfer.

As shown in FIG. 2, an optical interconnect 210 optically connects the optical unit 214A and the optical unit 214B. In some embodiments, an optical interconnect 210 may be embodied as an optical fiber. The optical interconnect 210 can be designed to guide light with less signal loss and allow for flexible routing of signals within the bonded structure 200, accommodating various design requirements and configurations. The optical interconnects 210 may facilitate high-speed data transfer under reduced latency between the optical units 214A and the optical unit 214B. The optical interconnect 210 may also be immune to electromagnetic interference (EMI), which can be a significant issue for electrical interconnects, especially in densely packed semiconductor packages.

In some embodiments, each of the processor dies 206A, 206B, 206C, 206D can directly communicate with each of the memory units 208A, 208B, 208C, 208D through the interconnect device 212A, the optical unit 214A, the optical interconnect 210, the optical unit 214B, and the interconnect device 212B. For example, through the interconnect device 212A, the optical unit 214A, the optical interconnect 210, the optical unit 214B, the processor die 206A can communicate with the memory unit 208C without going through another intermediary integrated device die (e.g., a processor die or a memory die). As another example, through the interconnect device 212A, the optical unit 214A, the optical interconnect 210, the optical unit 214B, the processor die 206C can communicate with the memory unit 208B without going through another intermediary integrated device die.

In contrast to the implementations of FIG. 1, the bonded structure 200 offers several advantages. First, each of the processor dies 206A, 206B, 206C, 206D can directly communicate with each of the memory units 208A, 208B, 208C, 208D through the optical interconnect 210 and interconnect devices 212A, 212B. This direct communication eliminates the need for intermediary dies or chips for relaying signals, thereby reducing latency and improving data transfer efficiency. In contrast, data may need to pass through one or more intermediary GPU dies during transmission under the implementation of FIG. 1, leading to increased communication latency and inefficiency. Additionally, bonded structure 200 leverages optical interconnects 210 and optical units 214A, 214B for signal transmission, which can enable high-speed data transfer between processor dies and memory units. For example, optical signals can be transmitted at speeds of several terabits per second (Tbps), exceeding the transmission capabilities of electrical interconnects used in semiconductor devices 100A, 100B. Further, optical communication used in bonded structure 200 may consume less energy compared with the copper wire-based communication in semiconductor devices 100A, 100B. As noted above, the energy used to transmit data optically can be less than 1 picojoule per bit (<1 pJ/bit), which may make the bonded structure 200 more energy-efficient. This reduced energy consumption may advantageously translate to lower heat generation, which is beneficial for thermal management and overall system efficiency of the bonded structure 200. Also, optical interconnects 210 in the bonded structure 200 may offer improved signal integrity and avoid complex wiring schemes associated with electrical interconnects in the semiconductor devices 100A, 100B. Optical signals transmitted through the optical interconnect 210 may experience less attenuation and are immune to electromagnetic interference (EMI), ensuring reliable and accurate data transmission. The use of optical interconnect 210 along with other components (e.g., the optical units 214A, 214B, the interconnect devices 212A, 212B) may enable more compact and efficient packaging or layout designs associated with the bonded structure 200, enabling the bonded structure 200 to handle a large number of input/output (I/O) connections within a limited space.

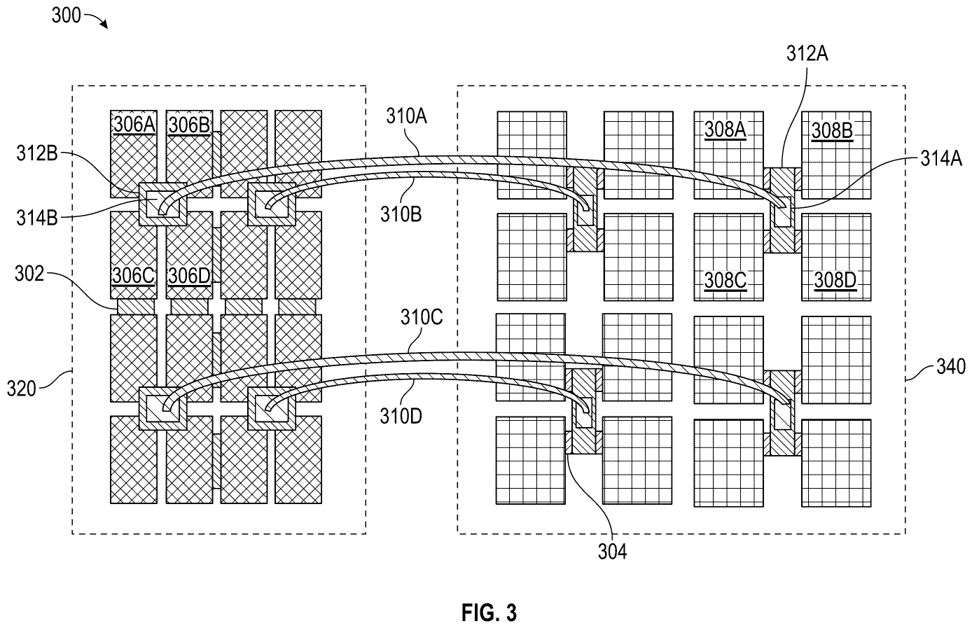

FIG. 3 illustrates a top schematic view of a bonded structure 300 with a cluster of processor dies and a cluster of memory units interconnected via optical interconnects and interconnect devices according to some embodiments. Unless otherwise noted, the components of FIG. 3 can be the same as or generally similar to like-numbered components of FIG. 2. The bonded structure 300 includes at least memory units 308A, 308B, 308C, 308D, processor dies 306A, 306B, 306C, 306D, connecting elements 304, connecting elements 302, interconnect devices 312A, 312B, optical units 314A, 314B, and optical interconnects 310A, 310B, 310C, 310D.

Through the optical interconnects 310A, 310B, 310C, 310D, the interconnect devices 312A, 312B, and the optical units 314A, 314B, processor dies (e.g., processor dies 306A, 306B, 306C, 306D) and memory units (e.g., memory units 308A, 308B, 308C, 308D) can more directly and flexibly communicate (e.g., without communicating through intermediary processor dies) with each other. In some embodiments, each of the processor dies 306A, 306B, 306C, 306D can directly communicate with each of the memory units 308A, 308B, 308C, 308D through the interconnect device 312A, the optical unit 314A, the optical interconnect 310A, the optical unit 314B, and the interconnect device 312B. For example, the processor die 306A can communicate with the memory unit 308C without going through another intermediary integrated device die (e.g., a processor die or a memory die). As another example, the processor die 306C can communicate with the memory unit 308B without going through another intermediary integrated device die.

As shown in FIG. 3, processor dies (e.g., including processor dies 306A, 306B, 306C, 306D) can be disposed in a cluster region 320. Memory units (e.g., including memory units 308A, 308B, 308C, 308D) can be disposed in a cluster region 340. By separating memory units and processor dies into distinct clusters, the bonded structure 300 may achieve improved thermal management. More specifically, processor dies 306A, 306B, 306C, 306D, which may generate more heat due to their intensive computational tasks, are grouped together and disposed in the cluster region 320. Memory units 308A, 308B, 308C, 308D, which may generate less heat compared with processor dies 306A, 306B, 306C, 306D, are grouped in the cluster region 340. This separation may allow for more efficient cooling and/or more effective thermal management to avoid heating issues (e.g., overheating, or thermal coupling) associated with the bonded structure 300. For example, one or more cooling elements (e.g., cooling chips, cooling dies, or the like; not shown in FIG. 3) may be disposed under the processor dies in the cluster region 320. The one or more cooling elements may dissipate heat generated by the processor dies 306A, 306B, 306C, 306D. More specifically, the one or more cooling elements may allow fluid to pass through to thermally manage the processor dies 306A, 306B, 306C, 306D for avoiding occurrence of overheating conditions.

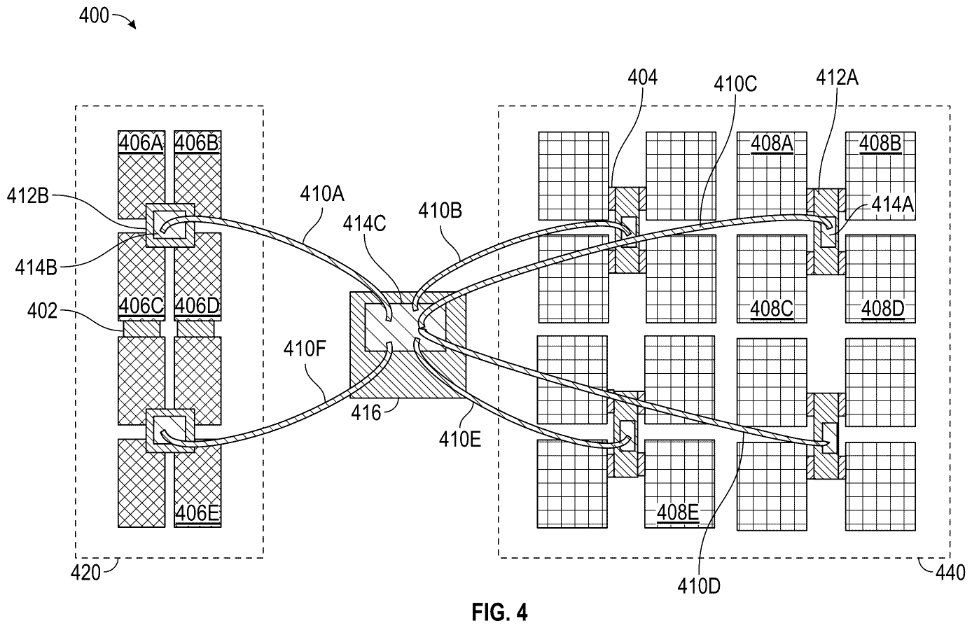

FIG. 4 illustrates a top schematic view of a bonded structure 400 with a cluster of processor dies and a cluster of memory units interconnected via an optical multiplexer, optical interconnects and interconnect devices according to some embodiments. Unless otherwise noted, the components of FIG. 4 can be the same as or generally similar to like-numbered components of FIGS. 2-3. The bonded structure 400 includes at least memory units 408A, 408B, 408C, 408D and 408E, processor dies 406A, 406B, 406C, 406D and 406E, connecting elements 404, connecting elements 402, interconnect devices 412A, 412B, optical units 414A, 414B, 414C, optical interconnects 410A, 410B, 410C, 410D, 410E, 410F, and an optical multiplexer 416.

As shown in FIG. 4, processor dies (e.g., including processor dies 406A, 406B, 406C, 406D, and 406E) and memory units (e.g., including memory units 408A, 408B, 408C, 408D, and 408E) can be respectively disposed in a cluster region 420 and a cluster region 440 to achieve improved thermal management as discussed above with reference to FIG. 3.

The optical unit 414C can be disposed (e.g., bonded, such as directly bonded using ZIBOND® or DBI® hybrid bonding technique without adhesive or an intervening layer) on the optical multiplexer 416 (or optical switch, optical controller, chip, etc.) to be vertically above the optical multiplexer 416. The vertical integration between the optical unit 414C and the optical multiplexer 416 may simplify the design and reduce the physical footprint of the bonded structure 400, thereby allowing for more compact and efficient semiconductor packages. The optical unit 414C may include diodes for transmitting and/or receiving optical signals as well as lasers, laser diodes, transceivers, trans-impedance amplifiers, etc. In some embodiments, the optical multiplexer 416 may be a network switch.

In some embodiments, the optical multiplexer 416 may include components (not shown in FIG. 4) such as optical waveguides, couplers, modulators, transceivers, amplifiers, and/or multiplexing circuits. The optical waveguides, couplers, and/or multiplexing circuits may be integrated into the optical multiplexer 416 as a compact module that can be positioned within the bonded structure 400 to facilitate efficient optical communication. For example, optical waveguides may guide the optical signals from various sources or components (e.g., optical interconnects 410A, 410B, 410C, 410D, 410E, 410F) into the optical multiplexer 416. These waveguides may be designed to reduce signal loss and maintain high signal integrity during transmission. Optical couplers within the optical multiplexer 416 may be used to combine the optical signals from different waveguides. These couplers may ensure that optical signals are efficiently merged without significant loss or interference, enabling the optical multiplexer 416 to handle multiple data streams simultaneously. The multiplexing circuits may be used for managing the combined optical signals and directing them into one or more optical fibers. The multiplexing circuits may be designed to handle high data rates and ensure that the multiplexed signals are transmitted with less latency and distortion.

In operation, the optical interconnects 410A, 410B, 410C, 410D, 410E, 410F may transmit data from different processor dies (e.g., processor dies 406A, 406B, 406C, 406D) and memory units (e.g., memory units 408A, 408B, 408C, 408D, 408E) within the bonded structure 400. The optical unit 414C may receive optical signals from the optical interconnects 410A, 410B, 410C, 410D, 410E, 410F. The optical signals received by the optical unit 414C may be guided into the optical waveguides within the optical multiplexer 416. The optical couplers of the optical multiplexer 416 may then combine the received optical signals, and/or merge multiple data streams into one or more multiplexed signals for further transmission. A multiplexed optical signal may then be directed into one or more of the optical interconnects 410A, 410B, 410C, 410D, 410E, 410F by the multiplexing circuits of the optical multiplexer 416. The one or more of the optical interconnects 410A, 410B, 410C, 410D, 410E, 410F may transmit the combined data stream to its destination, whether it be another processor die, memory unit, or an external device.

In some embodiments, at least through the optical multiplexer 416, each of processor dies in the cluster region 420 can communicate directly with (e.g., without through intermediary integrated device dies) each of memory units in the cluster region 440. For example, processor die 406A may communicate with memory unit 408B through interconnect device 412B, optical unit 414B, optical interconnect 410A, optical unit 414C, optical multiplexer 416, optical interconnect 410C, optical unit 414A, and an interconnect device 412A. As another example, processor die 406E may communicate with memory unit 408E through interconnect device 412B, optical unit 414B, optical interconnect 410F, optical unit 414C, optical multiplexer 416, optical interconnect 410E, optical unit 414A, an interconnect device 412A, and connecting element 404.

Advantageously, the optical multiplexer 416 may significantly increase the data transfer capacity by enabling multiple data streams to be transmitted simultaneously. This multiplexing capability may enable more efficient use of the available bandwidth, reducing the need for multiple physical connections and simplifying the interconnect architecture. The optical multiplexer 416 may facilitate direct optical communication between multiple integrated device dies and reduce the number of intermediary dies used for data transfer. This direct communication path may reduce latency, thereby achieving faster data exchange between processors and memory units. Additionally, the optical multiplexer 416 may support a large number of input/output (I/O) connections, enhancing the scalability and flexibility of the bonded structure 400.

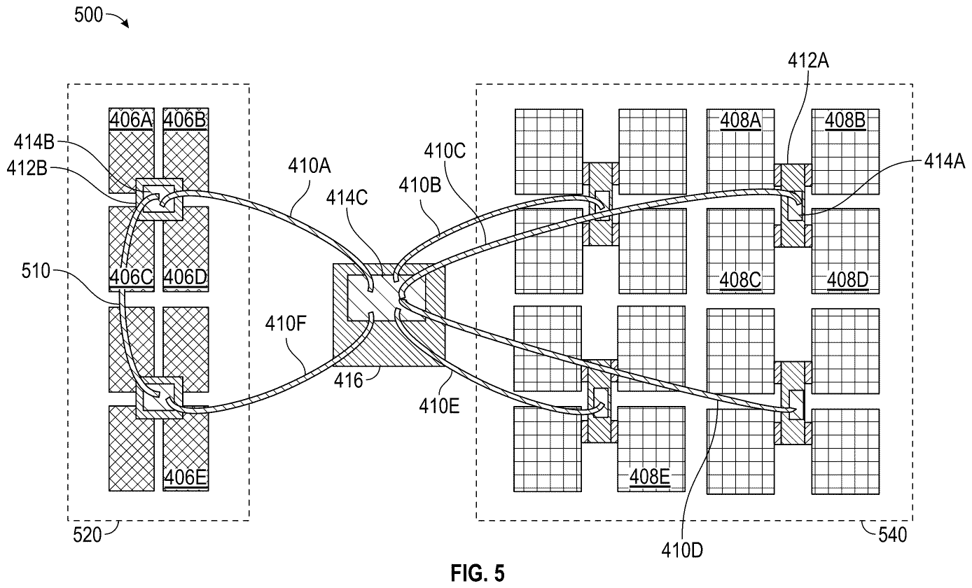

FIG. 5 illustrates a top schematic view of a bonded structure 500 with a cluster of processor dies and a cluster of memory units interconnected via an optical multiplexer, optical interconnects and interconnect devices according to some embodiments. Unless otherwise noted, the components of FIG. 5 can be the same as or generally similar to like-numbered components of FIGS. 2-4. The bonded structure 500 includes at least memory units 408A, 408B, 408C, 408D within a cluster region 540, processor dies 406A, 406B, 406C, 406D within a cluster region 520, connecting elements 404, connecting elements 402, interconnect devices 412A, 412B, optical units 414A, 414B, 414C, optical interconnects 410A, 410B, 410C, 410D, 410E, 410F, and optical multiplexer 416. The bonded structure 500 can be the same as the bonded structure 400 except that the bonded structure 500 further includes an optical interconnect 510.

As shown in FIG. 5, besides being able to communicate with memory units in the cluster region 540 through optical interconnects 410A, 410B, 410C, 410D, 410E, 410F, processors dies within the cluster region 520 may communicate with each other through the optical interconnect 510. For example, processor die 406C may communicate with processor die 406E through the interconnect device 412B, optical unit 414B, optical interconnect 510, optical unit 414B, and interconnect device 412B.

In some embodiments, at least through the optical multiplexer 416, each of processor dies in the cluster region 420 can communicate directly with (e.g., without through intermediary integrated device dies) each of memory units in the cluster region 440. For example, processor die 406A may communicate with memory unit 408B through interconnect device 412B, optical unit 414B, optical interconnect 410A, optical unit 414C, optical multiplexer 416, optical interconnect 410C, optical unit 414A, and interconnect device 412A. As another example, processor die 406E may communicate with memory unit 408E (not shown in FIG. 5) through interconnect device 412B, optical unit 414B, optical interconnect 410F, optical unit 414C, optical multiplexer 416, optical interconnect 410E, optical unit 414A, and interconnect device 412A.

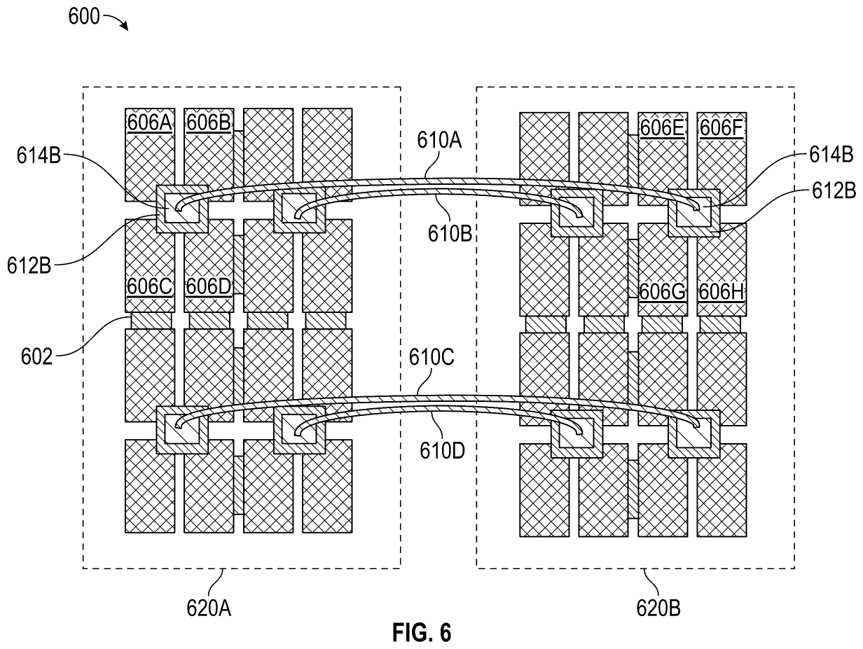

FIG. 6 illustrates a top schematic view of a bonded structure 600 with a cluster of processor dies and another cluster of processor dies interconnected via optical interconnects and interconnect devices according to some embodiments. Unless otherwise noted, the components of FIG. 6 can be the same as or generally similar to like-numbered components of FIGS. 2-5. The bonded structure 600 includes at least processor dies 606A, 606B, 606C, 606D, 606E, 606F, 606G, 606H, connecting elements 602, interconnect devices 612B, optical units 614B, and optical interconnects 610A, 610B, 610C, 610D.

Through the optical interconnects 610A, 610B, 610C, 610D, the interconnect devices 612B, and the optical units 614B, processor dies (e.g., processor dies 606A, 606B, 606C, 606D) within a cluster region 620A and processor dies (e.g., processor dies 606E, 606F, 606G, 606H) within a cluster region 620B can more directly and flexibly communicate (e.g., without communicating through intermediary processor dies) with each other. In some embodiments, each of the processor dies 606A, 606B, 606C, 606D can directly communicate with each of the processor dies 606E, 606F, 606G, 606H through the interconnect device 612B, the optical unit 614B, and the optical interconnect 610A. For example, the processor die 606A can communicate with the processor die 606E without going through another intermediary integrated device die (e.g., a processor die or a memory die). Although not illustrated in FIG. 6, in some embodiments, the bonded structure 600 can optionally include an optical multiplexer or an optical switch (e.g., the optical multiplexer 416) that facilitates communication between processor dies in the cluster region 620A and processor dies in the cluster region 620B. For example, when processor dies in the cluster region 620A are processing a computing task, additional processing power from processor dies in the cluster region 620B can be leveraged to process the computing task through the optical multiplexer. As another example, processor dies in the cluster regions 620A and 620B can work together and communicate with each other through the optical multiplexer to process a computing task.

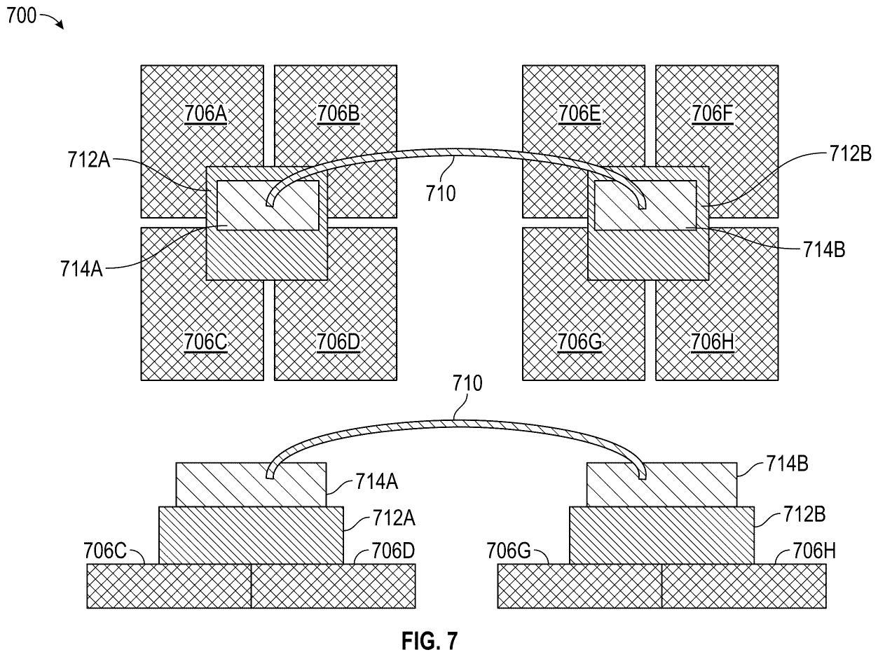

FIG. 7 illustrates a top schematic view and a side schematic sectional view of a bonded structure 700 with a first plurality of processor dies and a second plurality of processor dies interconnected via an optical interconnect and interconnect devices according to some embodiments. Unless otherwise noted, the components of FIG. 7 can be the same as or generally similar to like-numbered components of FIGS. 2-6. The bonded structure 700 includes processor units 706A, 706B, 706C, 706D, 706E, 706F, 706G, 706H, interconnect devices 712A, 712B, optical units 714A, 714B, and optical interconnect(s) 710.

The optical interconnects 710 can optically connect the optical unit 714A and the optical unit 714B. In some embodiments, each of the processor dies 706A, 706B, 706C, 706D can directly communicate with each of the processor dies 706E, 706F, 706G, 706H through the interconnect device 712A, the optical unit 714A, the optical interconnects 710, the optical unit 714B, and the interconnect device 712B. For example, through the interconnect device 712A, the optical unit 714A, the optical interconnect 710, the optical unit 714B, the processor die 706A can communicate with the processor die 706G without going through another intermediary integrated device die (e.g., a processor die or a memory die). As another example, through the interconnect device 712A, the optical unit 714A, the optical interconnect 710, the optical unit 714B, the processor die 706C can communicate with the processor die 706E without going through another intermediary integrated device die.

As shown in FIG. 7, the interconnect device 712A is disposed above the processor dies 706A, 706B, 706C, 706D. The optical unit 714A is disposed above the interconnect device 712A. In some embodiments, the interconnect device 712A can be hybrid bonded to the processor dies 706A, 706B, 706C, 706D. The optical unit 714A can be hybrid bonded to the interconnect device 712A. In some embodiments, the interconnect device 712A can comprise a single die that includes an optical driver/modulator and a bridge. Advantageously, using hybrid bonding techniques to stack the interconnect device 712A and the optical unit 714A above the processor dies 706A, 706B, 706C, 706D may enable integration of a large number of input/output (I/O) connections, more precise optical alignment, and improved thermal performance for the bonded structure 700.

As shown in FIG. 7, the interconnect device 712B is disposed above the processor dies 706E, 706F, 706G, 706H. The optical unit 714B is disposed above the interconnect device 712B. In some embodiments, the interconnect device 712B can be hybrid bonded to the processor dies 706E, 706F, 706G, 706H. The optical unit 714B can be hybrid bonded to the interconnect device 712B. In some embodiments, the interconnect device 712B can comprise a single die that includes an optical driver/modulator and a bridge. Advantageously, using hybrid bonding techniques to stack the interconnect device 712B and the optical unit 714B above the processor dies 706E, 706F, 706G, 706H may enable integration of a large number of input/output (I/O) connections, more precise optical alignment, and improved thermal performance for the bonded structure 700.

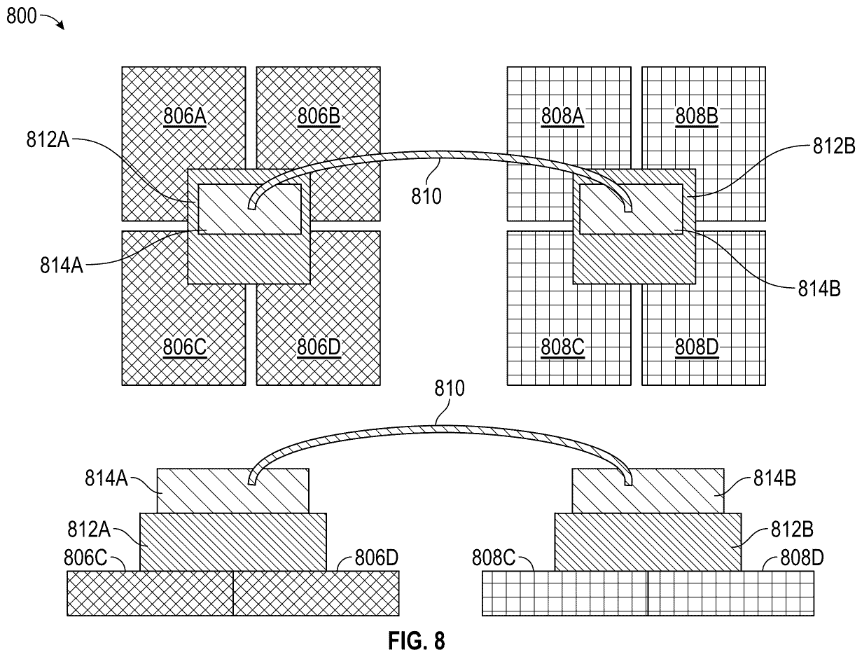

FIG. 8 illustrates a top schematic view and a side schematic sectional view of a bonded structure 800 with a plurality of processor dies and a plurality of memory units interconnected via an optical interconnect and interconnect devices according to some embodiments. Unless otherwise noted, the components of FIG. 8 can be the same as or generally similar to like-numbered components of FIGS. 2-7. The bonded structure 800 includes memory units 808A, 808B, 808C, 808D, processor dies 806A, 806B, 806C, 806D, interconnect devices 812A, 812B, optical units 814A, 814B, and optical interconnect(s) 810. The bonded structure 800 can be obtained by replacing the processor dies 706E, 706F, 706G, 706H of FIG. 7 with the memory units 808A, 808B, 808C, 808D shown in FIG. 8.

The optical interconnects 810 can optically connect the optical unit 814A and the optical unit 814B. In some embodiments, each of the processor dies 806A, 806B, 806C, 806D can directly communicate with each of the memory units 808A, 808B, 808C, 808D through the interconnect device 812A, the optical unit 814A, the optical interconnects 810, the optical unit 814B, and the interconnect device 812B. For example, through the interconnect device 812A, the optical unit 814A, the optical interconnect 810, the optical unit 814B, the processor die 806A can communicate with the memory unit 808D without going through another intermediary integrated device die (e.g., a processor die or a memory die). As another example, through the interconnect device 812A, the optical unit 814A, the optical interconnect 810, the optical unit 814B, the interconnect device 812B, the processor die 806C can communicate with the memory unit 808B without going through another intermediary integrated device die.

As shown in FIG. 8, the interconnect device 812A is disposed above the processor dies 806A, 806B, 806C, 806D. The optical unit 814A is disposed above the interconnect device 812A. In some embodiments, the interconnect device 812A can be hybrid bonded to the processor dies 806A, 806B, 806C, 806D. The optical unit 814A can be hybrid bonded to the interconnect device 812A. In some embodiments, the interconnect device 812A can comprise a single die that includes an optical driver/modulator and a bridge.

As shown in FIG. 8, the interconnect device 812B is disposed above the memory units 808A, 808B, 808C, 808D. The optical unit 814B is disposed above the interconnect device 812B. In some embodiments, the interconnect device 812B can be hybrid bonded to the memory units 808A, 808B, 808C, 808D. The optical unit 814B can be hybrid bonded to the interconnect device 812B. In some embodiments, the interconnect device 812B can comprise a single die that includes an optical driver/modulator and a bridge.

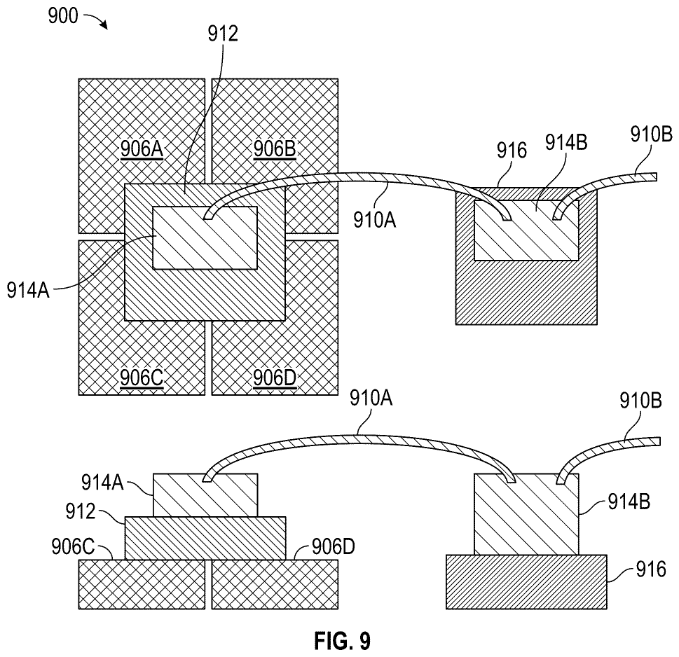

FIG. 9 illustrates a top schematic view and a side schematic sectional view of a bonded structure 900 with a plurality of processor dies and an optical multiplexer according to some embodiments. Unless otherwise noted, the components of FIG. 9 can be the same as or generally similar to like-numbered components of FIGS. 2-8. The bonded structure 900 includes processor dies 906A, 906B, 906C, 906D, interconnect device 912, optical units 914A, 914B, optical interconnects 910A, 910B, and optical multiplexer 916. As indicated in FIG. 9, the processor dies 906A, 906B, 906C, 906D may communicate with other integrated device dies (not shown in FIG. 9) through the interconnect device 912, the optical unit 914A, the optical interconnects 910A, the optical unit 914B, the optical multiplexer 916, and the optical interconnects 910B.

In some embodiments, at least through the optical multiplexer 916, the optical interconnects 910A, and the optical interconnects 910B, each of the processor dies 906A, 906B, 906C, 906D can communicate directly with (e.g., without through intermediary integrated device dies) each of the other integrated device dies.

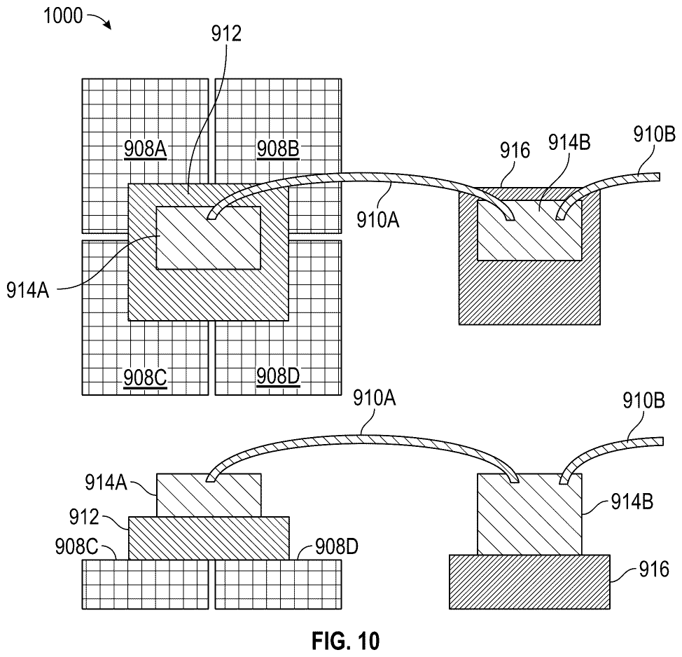

FIG. 10 illustrates a top schematic view and a side schematic sectional view of a bonded structure 1000 with a plurality of memory units and an optical multiplexer according to some embodiments. Unless otherwise noted, the components of FIG. 10 can be the same as or generally similar to like-numbered components of FIGS. 2-9. The bonded structure 1000 can be obtained by replacing the processor dies 906A, 906B, 906C, 906D of FIG. 9 with the memory units 908A, 908B, 908C, 908D shown in FIG. 10. The bonded structure 1000 includes memory units 908A, 908B, 908C, 908D, interconnect device 912, optical units 914A, 914B, optical interconnects 910A, 910B, and optical multiplexer 916. As indicated in FIG. 10, the memory units 908A, 908B, 908C, 908D may communicate with other integrated device dies (not shown in FIG. 10) through the interconnect device 912, the optical unit 914A, the optical interconnects 910A, the optical unit 914B, the optical multiplexer 916, and the optical interconnects 910B.

In some embodiments, at least through the optical multiplexer 916, the optical interconnects 910A, and the optical interconnects 910B, each of the memory units 908A, 908B, 908C, 908D can communicate directly with (e.g., without through intermediary integrated device dies) each of the other integrated device dies.

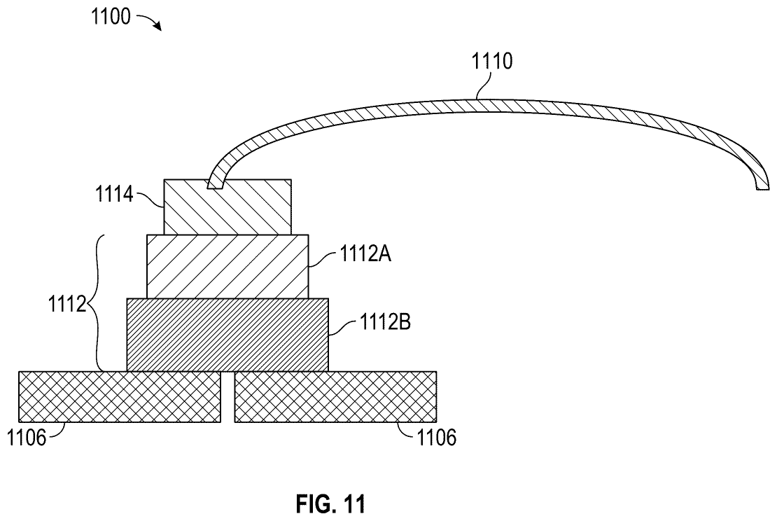

FIG. 11 illustrates a side schematic sectional view of a bonded structure 1100 with a plurality of processor dies, an interconnect device, an optical unit, and an optical interconnect according to some embodiments. Unless otherwise noted, the components of FIG. 11 can be the same as or generally similar to like-numbered components of FIGS. 2-10. The bonded structure 1100 includes processor dies 1106, an interconnect device 1112 that includes a bridge chip 1112B and an optical driver/modulator chip 1112A, an optical unit 1114, and optical interconnect(s) 1110.

The interconnect device 1112, optical unit 1114, and optical interconnects 1110 may enable the processor dies 1106 to communicate with other integrated device dies (not shown in FIG. 11). As shown in FIG. 11, the interconnect device 1112 includes the bridge chip 1112B and the optical driver/modulator chip 1112A.

### Direct Bonding

Various embodiments disclosed herein relate to directly bonded structures in which two or more elements can be directly bonded to one another without an intervening adhesive. Such processes and structures are referred to herein as “direct bonding” processes or “directly bonded” structures. Direct bonding can involve bonding of one material on one element and one material on the other element (also referred to as “uniform” direct bond herein), where the materials on the different elements need not be the same, without traditional adhesive materials. Direct bonding can also involve bonding of multiple materials on one element to multiple materials on the other element (e.g., hybrid bonding).

In some implementations (not illustrated), each bonding layer has one material. In these uniform direct bonding processes, only one material on each element is directly bonded. Example uniform direct bonding processes include the ZIBOND^{®} techniques commercially available from Adeia of San Jose, CA. The materials of opposing bonding layers on the different elements can be the same or different, and may comprise elemental or compound materials. For example, in some embodiments, nonconductive bonding layers can be blanket deposited over the base substrate portions without being patterned with conductive features (e.g., without pads). In other embodiments, the bonding layers can be patterned on one or both elements, and can be the same or different from one another, but one material from each element is directly bonded without adhesive across surfaces of the elements (or across the surface of the smaller element if the elements are differently-sized). In another implementation of uniform direct bonding, one or both of the nonconductive bonding layers may include one or more conductive features, but the conductive features are not involved in the bonding. For example, in some implementations, opposing nonconductive bonding layers can be uniformly directly bonded to one another, and through substrate vias (TSVs) can be subsequently formed through one element after bonding to provide electrical communication to the other element.

In various embodiments, the bonding layers 108a and/or 108b can comprise a non-conductive material such as a dielectric material or an undoped semiconductor material, such as undoped silicon, which may include native oxide. Suitable dielectric bonding surface or materials for direct bonding include but are not limited to inorganic dielectrics, such as silicon oxide, silicon nitride, or silicon oxynitride, or can include carbon, such as silicon carbide, silicon oxycarbonitride, low K dielectric materials, SiCOH dielectrics, silicon carbonitride or diamond-like carbon or a material comprising a diamond surface. Such carbon-containing ceramic materials can be considered inorganic, despite the inclusion of carbon. In some embodiments, the dielectric materials at the bonding surface do not comprise polymer materials, such as epoxy (e.g., epoxy adhesives, cured epoxies, or epoxy composites such as FR-4 materials), resin or molding materials.

In other embodiments, the bonding layers can comprise an electrically conductive material, such as a deposited conductive oxide material, e.g., indium tin oxide (ITO), as disclosed in U.S. Provisional Patent Application No. 63/524,564 , filed Jun. 30, 2023, the entire contents of which is incorporated by reference herein in its entirety for providing examples of conductive bonding layers without shorting contacts through the interface.

In direct bonding, first and second elements can be directly bonded to one another without an adhesive, which is different from a deposition process and results in a structurally different interface compared to that produced by deposition. In one application, a width of the first element in the bonded structure is similar to a width of the second element. In some other embodiments, a width of the first element in the bonded structure is different from a width of the second element. The width or area of the larger element in the bonded structure may be at least 10% larger than the width or area of the smaller element. Further, the interface between directly bonded structures, unlike the interface beneath deposited layers, can include a defect region in which nanometer-scale voids (nanovoids) are present. The nanovoids may be formed due to activation of one or both of the bonding surfaces (e.g., exposure to a plasma, explained below).

The bond interface between non-conductive bonding surfaces can include a higher concentration of materials from the activation and/or last chemical treatment processes compared to the bulk of the bonding layers. For example, in embodiments that utilize a nitrogen plasma for activation, a nitrogen concentration peak can be formed at the bond interface. In some embodiments, the nitrogen concentration peak may be detectable using secondary ion mass spectroscopy (SIMS) techniques. In various embodiments, for example, a nitrogen termination treatment (e.g., exposing the bonding surface to a nitrogen-containing plasma) can replace OH groups of a hydrolyzed (OH-terminated) surface with NH₂ molecules, yielding a nitrogen-terminated surface. In embodiments that utilize an oxygen plasma for activation, an oxygen concentration peak can be formed at the bond interface between non-conductive bonding surfaces. In some embodiments, the bond interface can comprise silicon oxynitride, silicon oxycarbonitride, or silicon carbonitride. The direct bond can comprise a covalent bond, which is stronger than van Der Waals bonds. The bonding layers can also comprise polished surfaces that are planarized to a high degree of smoothness.

In direct bonding processes, such as uniform direct bonding and hybrid bonding, two elements are bonded together without an intervening adhesive. In non-direct bonding processes that utilize an adhesive, an intervening material is typically applied to one or both elements to effectuate a physical connection between the elements. For example, in some adhesive-based processes, a flowable adhesive (e.g., an organic adhesive, such as an epoxy), which can include conductive filler materials, can be applied to one or both elements and cured to form the physical (rather than chemical or covalent) connection between elements. Typical organic adhesives lack strong chemical or covalent bonds with either element. In such processes, the connections between the elements are weak and/or readily reversed, such as by reheating or defluxing.

By contrast, direct bonding processes join two elements by forming strong chemical bonds (e.g., covalent bonds) between opposing nonconductive materials. For example, in direct bonding processes between nonconductive materials, one or both nonconductive surfaces of the two elements are planarized and chemically prepared (e.g., activated and/or terminated) such that when the elements are brought into contact, strong chemical bonds (e.g., covalent bonds) are formed, which are stronger than Van der Waals or hydrogen bonds. In some implementations (e.g., between opposing dielectric surfaces, such as opposing silicon oxide surfaces), the chemical bonds can occur spontaneously at room temperature upon being brought into contact. In some implementations, the chemical bonds between opposing non-conductive materials can be strengthened after annealing the elements.

As noted above, hybrid bonding is a species of direct bonding in which both non-conductive features directly bond to non-conductive features, and conductive features directly bond to conductive features of the elements being bonded. The non-conductive bonding materials and interface can be as described above, while the conductive bond can be formed, for example, as a direct metal-to-metal connection. In conventional metal bonding processes, a fusible metal alloy (e.g., solder) can be provided between the conductors of two elements, heated to melt the alloy, and cooled to form the connection between the two elements. The resulting bond often evinces sharp interfaces with conductors from both elements, and is subject to reversal by reheating. By way of contrast, direct metal bonding as employed in hybrid bonding does not require melting or an intermediate fusible metal alloy, and can result in strong mechanical and electrical connections, often demonstrating interdiffusion of the bonded conductive features with grain growth across the bonding interface between the elements, even without the much higher temperatures and pressures of thermocompression bonding.

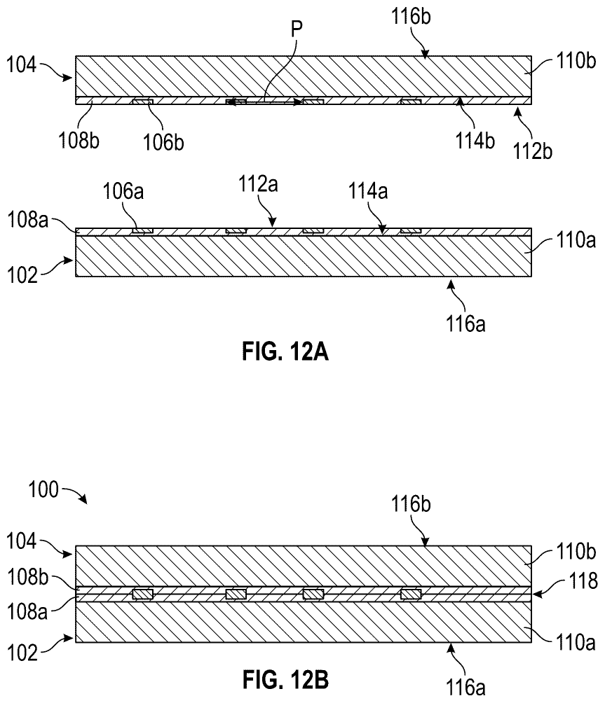

FIGS. 12A and 12B schematically illustrate cross-sectional side views of first and second elements 102, 104 prior to and after, respectively, a process for forming a directly bonded structure, and more particularly a hybrid bonded structure, according to some embodiments. In FIG. 12B, a bonded structure 100 comprises the first and second elements 102 and 104 that are directly bonded to one another at a bond interface 118 without an intervening adhesive. Conductive features 106a of a first element 102 may be electrically connected to corresponding conductive features 106b of a second element 104. In the illustrated hybrid bonded structure 100, the conductive features 106a are directly bonded to the corresponding conductive features 106b without intervening solder or conductive adhesive.

The conductive features 106a and 106b of the illustrated embodiment are embedded in, and can be considered part of, a first bonding layer 108a of the first element 102 and a second bonding layer 108b of the second element 104, respectively. Field regions of the bonding layers 108a, 108b extend between and partially or fully surround the conductive features 106a, 106b. The bonding layers 108a, 108b can comprise layers of non-conductive materials suitable for direct bonding, as described above, and the field regions are directly bonded to one another without an adhesive. The non-conductive bonding layers 108a, 108b can be disposed on respective front sides 114a, 114b of base substrate portions 110a, 110b.

The first and second elements 102, 104 can comprise microelectronic elements, such as semiconductor elements, including, for example, integrated device dies, wafers, passive devices, discrete active devices such as power switches, MEMS, etc. In some embodiments, the base substrate portion can comprise a device portion, such as a bulk semiconductor (e.g., silicon) portion of the elements 102, 104, and back-end-of-line (BEOL) interconnect layers over such semiconductor portions. The bonding layers 108a, 108b can be provided as part of such BEOL layers during device fabrication, as part of redistribution layers (RDL), or as specific bonding layers added to existing devices, with bond pads extending from underlying contacts. Active devices and/or circuitry can be patterned and/or otherwise disposed in or on the base substrate portions 110a, 110b, and can electrically communicate with at least some of the conductive features 106a, 106b. Active devices and/or circuitry can be disposed at or near the front sides 114a, 114b of the base substrate portions 110a, 110b, and/or at or near opposite backsides 116a, 116b of the base substrate portions 110a, 110b. In other embodiments, the base substrate portions 110a, 110b may not include active circuitry, but may instead comprise dummy substrates, passive interposers, passive optical elements (e.g., glass substrates, gratings, lenses), etc. The bonding layers 108a, 108b are shown as being provided on the front sides of the elements, but similar bonding layers can be additionally or alternatively provided on the back sides of the elements.

In some embodiments, the base substrate portions 110a, 110b can have significantly different coefficients of thermal expansion (CTEs), and bonding elements that include such different based substrate portions can form a heterogenous bonded structure. The CTE difference between the base substrate portions 110a and 110b, and particularly between bulk semiconductor (typically single crystal) portions of the base substrate portions 110a, 110b, can be greater than 5 ppm/° C. or greater than 10 ppm/° C. For example, the CTE difference between the base substrate portions 110a and 110b can be in a range of 5 ppm/° C. to 100 ppm/° C., 5 ppm/° C. to 40 ppm/° C., 10 ppm/° C. to 100 ppm/° C., or 10 ppm/° C. to 40 ppm/° C.

In some embodiments, one of the base substrate portions 110a, 110b can comprise optoelectronic single crystal materials, including perovskite materials, that are useful for optical piezoelectric or pyroelectric applications, and the other of the base substrate portions 110a, 110b comprises a more conventional substrate material. For example, one of the base substrate portions 110a, 110b comprises lithium tantalate (LiTaO3) or lithium niobate (LiNbO3), and the other one of the base substrate portions 110a, 110b comprises silicon (Si), quartz, fused silica glass, sapphire, or a glass. In other embodiments, one of the base substrate portions 110a, 110b comprises a III-V single semiconductor material, such as gallium arsenide (GaAs) or gallium nitride (GaN), and the other one of the base substrate portions 110a, 110b can comprise a non-III-V semiconductor material, such as silicon (Si), or can comprise other materials with similar CTE, such as quartz, fused silica glass, sapphire, or a glass. In still other embodiments, one of the base substrate portions 110a, 110b comprises a semiconductor material and the other of the base substrate portions 110a, 110b comprises a packaging material, such as a glass, organic or ceramic substrate.

In some arrangements, the first element 102 can comprise a singulated element, such as a singulated integrated device die. In other arrangements, the first element 102 can comprise a carrier or substrate (e.g., a semiconductor wafer) that includes a plurality (e.g., tens, hundreds, or more) of device regions that, when singulated, forms a plurality of integrated device dies, though in other embodiments such a carrier can be a package substrate or a passive or active interposer. Similarly, the second element 104 can comprise a singulated element, such as a singulated integrated device die. In other arrangements, the second element 104 can comprise a carrier or substrate (e.g., a semiconductor wafer). The embodiments disclosed herein can accordingly apply to wafer-to-wafer (W2W), die-to-die (D2D), or die-to-wafer (D2W) bonding processes. In W2W processes, two or more wafers can be directly bonded to one another (e.g., direct hybrid bonded) and singulated using a suitable singulation process. After singulation, side edges of the singulated structure (e.g., the side edges of the two bonded elements) can be substantially flush (substantially aligned x-y dimensions) and/or the edges of the bonding interfaces for both bonded and singulated elements can be coextensive, and may include markings indicative of the common singulation process for the bonded structure (e.g., saw markings if a saw singulation process is used).

While only two elements 102, 104 are shown, any suitable number of elements can be stacked in the bonded structure 100. For example, a third element (not shown) can be stacked on the second element 104, a fourth element (not shown) can be stacked on the third element, and so forth. In such implementations, through substrate vias (TSVs) can be formed to provide vertical electrical communication between and/or among the vertically-stacked elements. Additionally or alternatively, one or more additional elements (not shown) can be stacked laterally adjacent one another along the first element 102. In some embodiments, a laterally stacked additional element may be smaller than the second element. In some embodiments, the bonded structure can be encapsulated with an insulating material, such as an inorganic dielectric (e.g., silicon oxide, silicon nitride, silicon oxynitrocarbide, etc.). One or more insulating layers can be provided over the bonded structure. For example, in some implementations, a first insulating layer can be conformally deposited over the bonded structure, and a second insulating layer (which may include be the same material as the first insulating layer, or a different material) can be provided over the first insulating layer.

To effectuate direct bonding between the bonding layers 108a, 108b, the bonding layers 108a, 108b can be prepared for direct bonding. Non-conductive bonding surfaces 112a, 112b at the upper or exterior surfaces of the bonding layers 108a, 108b can be prepared for direct bonding by polishing, for example, by chemical mechanical polishing (CMP). The roughness of the polished bonding surfaces 112a, 112b can be less than 30 Å rms. For example, the roughness of the bonding surfaces 112a and 112b can be in a range of about 0.1 Å rms to 15 Å rms, 0.5 Å rms to 10 Å rms, or 1 Å rms to 5 Å rms. Polishing can also be tuned to leave the conductive features 106a, 106b recessed relative to the field regions of the bonding layers 108a, 108b.

Preparation for direct bonding can also include cleaning and exposing one or both of the bonding surfaces 112a, 112b to a plasma and/or etchants to activate at least one of the surfaces 112a, 112b. In some embodiments, one or both of the surfaces 112a, 112b can be terminated with a species after activation or during activation (e.g., during the plasma and/or etch processes). Without being limited by theory, in some embodiments, the activation process can be performed to break chemical bonds at the bonding surface(s) 112a, 112b, and the termination process can provide additional chemical species at the bonding surface(s) 112a, 112b that alters the chemical bond and/or improves the bonding energy during direct bonding. In some embodiments, the activation and termination are provided in the same step, e.g., a plasma to activate and terminate the surface(s) 112a, 112b. In other embodiments, one or both of the bonding surfaces 112a, 112b can be terminated in a separate treatment to provide the additional species for direct bonding. In various embodiments, the terminating species can comprise nitrogen. For example, in some embodiments, the bonding surface(s) 112a, 112b can be exposed to a nitrogen-containing plasma. Other terminating species can be suitable for improving bonding energy, depending upon the materials of the bonding surfaces 112a, 112b. Further, in some embodiments, the bonding surface(s) 112a, 112b can be exposed to fluorine. For example, there may be one or multiple fluorine concentration peaks at or near a bond interface 118 between the first and second elements 102, 104. Typically, fluorine concentration peaks occur at interfaces between material layers. Additional examples of activation and/or termination treatments may be found in U.S. Pat. No. 9,391,143 at Col. 5, line 55 to Col. 7, line 3; Col. 8, line 52 to Col. 9, line 45; Col. 10, lines 24-36; Col. 11, lines 24-32, 42-47, 52-55, and 60-64; Col. 12, lines 3-14, 31-33, and 55-67; Col. 14, lines 38-40 and 44-50; and 10,434,749 at Col. 4, lines 41-50; Col. 5, lines 7-22, 39, 55-61; Col. 8, lines 25-31, 35-40, and 49-56; and Col. 12, lines 46-61, the activation and termination teachings of which are incorporated by reference herein.

Thus, in the directly bonded structure 100, the bond interface 118 between two non-conductive materials (e.g., the bonding layers 108a, 108b) can comprise a very smooth interface with higher nitrogen (or other terminating species) content and/or fluorine concentration peaks at the bond interface 118. In some embodiments, the nitrogen and/or fluorine concentration peaks may be detected using various types of inspection techniques, such as SIMS techniques. The polished bonding surfaces 112a and 112b can be slightly rougher (e.g., about 1 Å rms to 30 Å rms, 3 Å rms to 20 Å rms, or possibly rougher) after an activation process. In some embodiments, activation and/or termination can result in slightly smoother surfaces prior to bonding, such as where a plasma treatment preferentially erodes high points on the bonding surface.

The non-conductive bonding layers 108a and 108b can be directly bonded to one another without an adhesive. In some embodiments, the elements 102, 104 are brought together at room temperature, without the need for application of a voltage, and without the need for application of external pressure or force beyond that used to initiate contact between the two elements 102, 104. Contact alone can cause direct bonding between the non-conductive surfaces of the bonding layers 108a, 108b (e.g., covalent dielectric bonding). Subsequent annealing of the bonded structure 100 can cause the conductive features 106a, 106b to directly bond.

In some embodiments, prior to direct bonding, the conductive features 106a, 106b are recessed relative to the surrounding field regions, such that a total gap between opposing contacts after dielectric bonding and prior to anneal is less than 15 nm, or less than 10 nm. Because the recess depths for the conductive features 106a and 106b can vary across each element, due to process variation, the noted gap can represent a maximum or an average gap between corresponding conductive features 106a, 106b of two joined elements (prior to anneal). Upon annealing, the conductive features 106a and 106b can expand and contact one another to form a metal-to-metal direct bond.

During annealing, the conductive features 106a, 106b (e.g., metallic material) can expand while the direct bonds between surrounding non-conductive materials of the bonding layers 108a, 108b resist separation of the elements, such that the thermal expansion increases the internal contact pressure between the opposing conductive features. Annealing can also cause metallic grain growth across the bonding interface, such that grains from one element migrate across the bonding interface at least partially into the other element, and vice versa. Thus, in some hybrid bonding embodiments, opposing conductive materials are joined without heating above the conductive materials'melting temperature, such that bonds can form with lower anneal temperatures compared to soldering or thermocompression bonding.

In various embodiments, the conductive features 106a, 106b can comprise discrete pads, contacts, electrodes, or traces at least partially embedded in the non-conductive field regions of the bonding layers 108a, 108b. In some embodiments, the conductive features 106a, 106b can comprise exposed contact surfaces of TSVs (e.g., through silicon vias).

As noted above, in some embodiments, in the elements 102, 104 of FIG. 12A prior to direct bonding, portions of the respective conductive features 106a and 106b can be recessed below the non-conductive bonding surfaces 112a and 112b, for example, recessed by less than 30 nm, less than 20 nm, less than 15 nm, or less than 10 nm, for example, recessed in a range of 2 nm to 20 nm, or in a range of 4 nm to 10 nm. Due to process variation, both dielectric thickness and conductor recess depths can vary across an element. Accordingly, the above recess depth ranges may apply to individual conductive features 106a, 106b or to average depths of the recesses relative to local non-conductive field regions. Even for an individual conductive feature 106a, 106b, the vertical recess can vary across the feature, and so can be measured at or near the lateral middle or center of the cavity in which a given conductive feature 106a, 106b is formed, or can be measured at the sides of the cavity.

Beneficially, the use of hybrid bonding techniques (such as Direct Bond Interconnect, or DBI^{®}, techniques commercially available from Adeia of San Jose, CA) can enable high density of connections between conductive features 106a, 106b across the direct bond interface 118 (e.g., small or fine pitches for regular arrays).

In some embodiments, a pitch p of the conductive features 106a, 106b, such as conductive traces embedded in the bonding surface of one of the bonded elements, may be less than 40 μm, less than 20 μm, less than 10 μm, less than 5 μm, less than 2 μm, or even less than 1 μm. For some applications, the ratio of the pitch of the conductive features 106a and 106b to one of the lateral dimensions (e.g., a diameter) of the bonding pad is less than is less than 20, or less than 10, or less than 5, or less than 3 and sometimes desirably less than 2. In various embodiments, the conductive features 106a and 106b and/or traces can comprise copper or copper alloys, although other metals may be suitable, such as nickel, aluminum, or alloys thereof. The conductive features disclosed herein, such as the conductive features 106a and 106b, can comprise fine-grain metal (e.g., a fine-grain copper). Further, a major lateral dimension (e.g., a pad diameter) can be small as well, e.g., in a range of about 0.25 μm to 30 μm, in a range of about 0.25 μm to 5 μm, or in a range of about 0.5 μm to 5 μm.

For hybrid bonded elements 102, 104, as shown, the orientations of one or more conductive features 106a, 106b from opposite elements can be opposite to one another. As is known in the art, conductive features in general can be formed with close to vertical sidewalls, particularly where directional reactive ion etching (RIE) defines the conductor sidewalls either directly though etching the conductive material or indirectly through etching surrounding insulators in damascene processes. However, some slight taper to the conductor sidewalls can be present, wherein the conductor becomes narrower farther away from the surface initially exposed to the etch. The taper can be even more pronounced when the conductive sidewall is defined directly or indirectly with isotropic wet or dry etching. In the illustrated embodiment, at least one conductive feature 106b in the bonding layer 108b (and/or at least one internal conductive feature, such as a BEOL feature) of the upper element 104 may be tapered or narrowed upwardly, away from the bonding surface 112b. By way of contrast, at least one conductive feature 106a in the bonding layer 108a (and/or at least one internal conductive feature, such as a BEOL feature) of the lower element 102 may be tapered or narrowed downwardly, away from the bonding surface 112a. Similarly, any bonding layers (not shown) on the backsides 116a, 116b of the elements 102, 104 may taper or narrow away from the backsides, with an opposite taper orientation relative to front side conductive features 106a, 106b of the same element.

As described above, in an anneal phase of hybrid bonding, the conductive features 106a, 106b can expand and contact one another to form a metal-to-metal direct bond. In some embodiments, the materials of the conductive features 106a, 106b of opposite elements 102, 104 can interdiffuse during the annealing process. In some embodiments, metal grains grow into each other across the bond interface 118. In some embodiments, the metal is or includes copper, which can have grains oriented along the 111 crystal plane for improved copper diffusion across the bond interface 118. In some embodiments, the conductive features 106a and 106b may include nanotwinned copper grain structure, which can aid in merging the conductive features during anneal. There is substantially no gap between the non-conductive bonding layers 108a and 108b at or near the bonded conductive features 106a and 106b. In some embodiments, a barrier layer may be provided under and/or laterally surrounding the conductive features 106a and 106b (e.g., which may include copper). In other embodiments, however, there may be no barrier layer under the conductive features 106a and 106b.

### Additional Embodiments

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and embodiments of the embodiments may be made and still fall within the scope of the disclosure. It should be understood that various features and embodiments of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative embodiments, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A; B; C; A and B; A and C; B and C; and A, B, and C. Conjunctive language such as the phrase “at least one of X, Y and Z,” unless specifically stated otherwise, is understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded ta fair interpretation consistent with this disclosure, the principles and the novel features disclosed herein.

1. A structure comprising:
a first plurality of integrated device dies;
an interconnect device electrically connected to the first plurality of integrated device dies; and
an optical unit disposed vertically above the interconnect device, the optical unit optically connecting to an optical interconnect,
wherein the first plurality of integrated device dies communicate with a second plurality of integrated device dies at least through the interconnect device, the optical unit, and the optical interconnect.

2. The structure of claim 1, wherein the interconnect device electrically connects the first plurality of integrated device dies with each other.

3. The structure of claim 1, wherein the interconnect device converts an electrical signal received from the first plurality of integrated device dies to an optical signal.

4. The structure of claim 3, wherein the optical unit transmits the optical signal through the optical interconnect.

5. The structure of claim 1, wherein the interconnect device converts an optical signal received from the optical unit to an electrical signal.

6. The structure of claim 5, wherein the interconnect device transmits the electrical signal to the first plurality of integrated device dies.

7. The structure of claim 1, wherein the interconnect device comprises an optical driver die or an optical modulator die.

8. The structure of claim 1, wherein the interconnect device comprises a bridge die.

9. The structure of claim 1, wherein the interconnect device includes a single die that comprises an optical driver and a bridge.

10. (canceled)

11. (canceled)

12. (canceled)

13. (canceled)

14. The structure of claim 1, wherein the first plurality of integrated device dies are disposed in a first cluster region, and the second plurality of integrated device dies are disposed in a second cluster region.

15. (canceled)

16. (canceled)

17. (canceled)

18. (canceled)

19. The structure of claim 1, wherein the interconnect device is hybrid bonded to the first plurality of integrated device dies.

20. (canceled)

21. A structure comprising:
a first plurality of integrated device dies;
a first interconnect device electrically connected to the first plurality of integrated device dies;
a first optical unit disposed vertically above the first interconnect device; and
an optical interconnect comprising a first end and a second end, the first end of the optical interconnect optically connecting to the first optical unit,
wherein the first plurality of integrated device dies communicate with a second plurality of integrated device dies at least through the first interconnect device, the first optical unit, and the optical interconnect.

22. The structure of claim 21, further comprising:
the second plurality of integrated device dies;
a second interconnect device electrically connected to the second plurality of integrated device dies; and
a second optical unit disposed vertically above the second interconnect device, the second end of the optical interconnect optically connecting to the second optical unit.

23. The structure of claim 21, wherein the first interconnect device electrically connects the first plurality of integrated device dies with each other.

24. The structure of claim 21, wherein the first interconnect device is disposed vertically above the first plurality of integrated device dies, and wherein the first interconnect device is hybrid bonded to the first plurality of integrated device dies.

25. A structure comprising:
a first plurality of integrated device dies;
a first interconnect device electrically connected to the first plurality of integrated device dies; and
a first optical unit disposed vertically above the first interconnect device,
wherein the first interconnect device and the first optical unit enable the first plurality of integrated device dies to communicate with a second plurality of integrated device dies.

26. The structure of claim 25, further comprising:
an optical multiplexer device;
a second optical unit disposed vertically above the optical multiplexer device; and
a first optical interconnect optically connecting the first optical unit and the second optical unit.

27. The structure of claim 26, further comprising:
the second plurality of integrated device dies;
a second interconnect device electrically connected to the second plurality of integrated device dies;
a third optical unit disposed vertically above the second interconnect device; and
a second optical interconnect optically connecting the second optical unit and the third optical unit,
wherein the first plurality of integrated device dies communicate with the second plurality of integrated device dies at least through the first interconnect device, the first optical unit, the first optical interconnect, the second optical unit, the optical multiplexer device, the second optical interconnect, the third optical unit, and the second interconnect device.

28. The structure of claim 25, wherein the first interconnect device electrically connects the first plurality of integrated device dies with each other.

29. (canceled)

30. The structure of claim 25, wherein the first interconnect device is disposed vertically above the first plurality of integrated device dies, and wherein the first interconnect device is hybrid bonded to the first plurality of integrated device dies.

31.-38. (canceled)
